(19) United States
(12) Patent Application Publication
(10) Pub. No.: US 2024/0332588 A1
(43) Pub. Date: Oct. 3, 2024

(54) FUEL CELL STACK AND MANUFACTURING METHOD OF CASE

(71) Applicant: Honda Motor Co., Ltd., Tokyo (JP)

(72) Inventors: Yuta Oshima, Saitama (JP); Masaaki Sakano, Saitama (JP)

(21) Appl. No.: 18/588,139

(22) Filed: Feb. 27, 2024

(30) Foreign Application Priority Data
Mar. 30, 2023 (JP) 2023-054854

(51) Int. Cl. H01M 8/2475; H01M 8/2404

(52) U.S. Cl. CPC H01M 8/2475; H01M 8/2404

(57) ABSTRACT

A fuel cell stack including a cell stacked body and a case having four side walls facing four side surfaces of the cell stacked body extending in a predetermined direction to form an accommodation space accommodating the cell stacked body. The side walls are configured by a substantially plate shaped member having a substantially rectangular shape. The case includes joint portions joined by friction stir welding on connection surfaces between first and second side walls, between the second and third side walls, between the third and fourth side walls and between the fourth and first side walls, respectively, and a machined portion on a first surface of the side wall facing an accommodation space.

### CROSS-REFERENCE TO RELATED APPLICATION

This application is based upon and claims the benefit of priority from Japanese Patent Application No. 2023-054854 filed on Mar. 30, 2023, the content of which is incorporated herein by reference.

### BACKGROUND OF THE INVENTION

### Field of the Invention

This invention relates to a fuel cell stack and a manufacturing method of a case used for the fuel cell stack.

### Description of the Related Art

In recent years, technological developments have been made on a fuel cell that contribute to energy efficiency in order to ensure access to energy that is affordable, reliable, sustainable and advanced by more people. Conventionally, as a technology related to a fuel cell stack used in a fuel cell of this type, there has been known a manufacturing method in which a split-shaped first and second cases each having a substantially U-shaped cross-section are joined together using friction stir welding to manufacture a case for accommodating a cell stacked body of the fuel cell stack. Such a manufacturing method is described, for example, in Japanese Patent Publication No. 6388004 (JP 6388004 B). In the manufacturing method described in JP 6388004 B, the first and second cases are manufactured by casting, and then the first and second cased are joined together by friction stir welding to manufacture a case having an accommodation space for accommodating the cell stuck.

The type of case may require to machine an inner wall of the case facing the accommodation space. However, in order to machine the inner wall of the case, a dedicated tool is required, which entails an increase in cost.

### SUMMARY OF THE INVENTION

An aspect of the present invention is a fuel cell stack including: a cell stacked body configured to stack alternately a unitized electrode assembly having an electrolyte membrane and an electrode, and a separator in a predetermined direction, the cell stacked body having a substantially rectangular parallelepiped shape; and a case having four side walls facing four side surfaces of the cell stacked body extending in the predetermined direction to form an accommodation space accommodating the cell stacked body, the four side walls being a first side wall, a second side wall continuous with the first side wall, a third side wall continuous with the second side wall, and a fourth side wall continuous with the third side wall and the first side wall. Each of the four side walls includes a first surface facing the accommodation space and a second surface on an opposite side of the accommodation space and is configured by a substantially plate-shaped member having a substantially rectangular shape, the case includes a joint portion joined by a friction stir welding on each of a connection surface between the first side wall and the second side wall, a connection surface between the second side wall and the third side wall, a connection surface between the third side wall and the fourth side wall, and a connection surface between the fourth side wall and the first side wall, and the case further includes a machined portion on at least the first surface of the first side wall facing the accommodation space.

Another aspect of the present invention is a manufacturing method of a case including: manufacturing four side walls each including a first surface ant a second surface on an opposite side of the first surface and formed in a substantially rectangular and plate shape, the four side walls including a first side wall, a second side wall, a third side wall and a fourth side wall; machining at least the first surface of the first side wall among the four side walls; and joining by a friction stir welding the first side wall and the second side wall disposed perpendicular to each other, the second side wall and the third side wall disposed perpendicular to each other, the third side wall and the fourth side wall disposed perpendicular to each other, and the fourth side wall and the first side wall disposed perpendicular to each other in a state where the first surface of the first side wall and the first surface of the third side wall are disposed opposite to each other and the first surface of the second side wall and the first surface of the fourth side wall are disposed opposite to each other, the friction stir welding being performing by pressing a joining tool onto a connection surface between the first side wall and the second side wall, a connection surface between the second side wall and the third side wall, a connection surface between the third side wall and the fourth side wall, and a connection surface between the fourth side wall and the first side wall while rotating the joining tool along the connection surface, respectively. The joining includes disposing a jig in a space surrounded by the first side wall, the second side wall, the third side wall and the fourth side wall.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to an embodiment of the present invention;

FIG. 2 is a cross-sectional view taken along II-II line in FIG. 1;

FIG. 3 is a view showing an example of a joining step of a case included in the fuel cell stack in FIG. 1;

FIG. 4 is a view showing an example of a connection surface of side walls joined to each other;

FIG. 5A is a view showing an example of a side wall manufacturing step in a manufacturing method of a case according to the embodiment of the present invention;

FIG. 5B is a view showing an example of a pre-processing step following FIG. 5A;

FIG. 5C is a view showing an example of a joining step following FIG. 5B and an example different from FIG. 3; and

FIG. 5D is a view showing an example of a post-processing step following FIG. 5C.

### DETAILED DESCRIPTION OF THE INVENTION

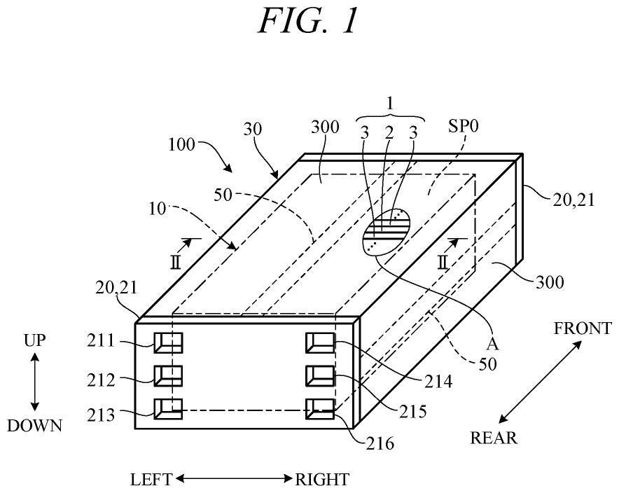

Hereinafter, an embodiment of the present invention will be described with reference to FIGS. 1 to 5D. A fuel cell stack according to an embodiment of the present invention is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

First, an overall configuration of the fuel cell stack will be schematically described. FIG. 1 is an exploded perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions are not necessarily identical to a front-rear direction, a left-right direction, and an up-down direction of the vehicle. For example, the front-rear direction in FIG. 1 may be the front-rear direction, the left-right direction, or the up-down direction of the vehicle.

As illustrated in FIG. 1, the fuel cell stack 100 includes a cell stacked body 10, a pair of end units 20 disposed at the front and rear ends of the cell stacked body 10, and a case 30 surrounding the cell stacked body 10, and has a substantially rectangular parallelepiped shape as a whole.

The case 30 has four side walls 300 opposed to the upper face, right face, lower face, and left face of the cell stacked body 10, each of which has a substantially rectangular shape. An accommodation space SP0 having a substantially box shape with the front face and the rear face opened is formed by these four side walls 300. The case 103 is made of a metal such as aluminum or iron. The front face and rear face of the case 30 are covered by the end units 20. The end units 20 include end plate 21 having a substantially rectangular shape and made of metal, and the front face ant the rear face of the case 30 are covered by the end units 20.

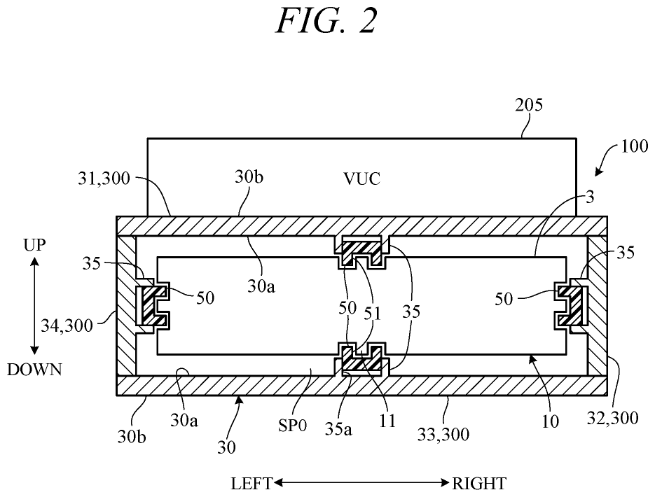

A guide member 50 (FIG. 2) is interposed between the cell stacked body 10 and each side wall 300 of the case 30. The guide member 50 is a rod shaped or plate shaped member, and attached to the inner surface of the side wall 300 in advance. In “A” part in FIG. 1, a portion of the side wall 300 of the case 30 broken is shown. As illustrated in “A” part of FIG. 1, the cell stacked body 10 is configured by stacking a plurality of power generation cells 1 (for convenience, only a single cell 1 is illustrated) in the front-rear direction while being guided by the guide members 50.

The power generation cell 1 includes a unitized electrode assembly (UEA) 2 having a joint body including an electrolyte membrane and an electrode, and separators 3 and 3 that are disposed on both sides in the front-rear direction of the unitized electrode assembly 2 and sandwich the unitized electrode assembly 2. The unitized electrode assembly 2 and the separators 3 are alternately disposed in the front-rear direction. The unitized electrode assembly 2 may be called a membrane electrode structural body.

The separator 3 includes a pair of front and rear metal thin plates having a corrugated cross section, and is integrally formed by joining outer peripheral edges of the pair of thin plates. For the separator 3, a conductive material having excellent corrosion resistance is used, and for example, titanium, a titanium alloy, stainless steel, or the like can be used. The pair of thin plates are formed in an uneven shape by press-molding or the like so that a cooling flow path through which a cooling medium (for example, water) flows is formed inside the separator 3 (between the pair of thin plates), and a power generation surface of the power generation cell 1 is cooled by the flow of the cooling medium.

The front separator 3 of the unitized electrode assembly 2 is, for example, a separator on an anode side (anode separator), and an anode flow path through which a fuel gas containing hydrogen flows is formed between the anode separator 3 and the unitized electrode assembly 2. The rear separator 3 of the unitized electrode assembly 2 is, for example, a separator on a cathode side (cathode separator), and a cathode flow path through which an oxidant gas containing oxygen flows is formed between the cathode separator 3 and the unitized electrode assembly 2.

The unitized electrode assembly 2 includes a membrane electrode assembly (MEA) and a frame made of resin supporting a peripheral edge of the membrane electrode assembly. The membrane electrode assembly includes an electrolyte membrane, an anode electrode provided on the front surface of the electrolyte membrane and a cathode electrode provided on the rear surface of the electrolyte membrane. The electrolyte membrane is, for example, a solid polymer electrolyte membrane. The anode electrode has a catalyst layer formed on the front surface of the electrolyte membrane and served as a reaction field of electrode reaction, and a gas diffusion layer formed on a front surface of the electrode catalyst layer to spread and supply the reaction gas. The cathode electrode has an electrode catalyst layer formed on the rear surface of the electrolyte membrane and served as a reaction field of electrode reaction, and a gas diffusion layer formed on a rear surface of the electrode catalyst layer to spread and supply the reaction gas.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the unitized electrode assembly 2.

At the front end plate 21, through-holes 211 to 216 are opened. The through-hole 211 is provided to supply the fuel gas inside the cell stacked body 10. The through-hole 212 is provided to discharge the cooling medium out of the cell stacked body 10. The through-hole 213 is provided to discharge the oxidant gas out of the cell stacked body 10. The through-hole 214 is provided to supply the oxidant gas inside the cell stacked body 10. The through-hole 215 is provided to supply the cooling medium inside the cell stacked body 10. The through-hole 216 is provided to discharge the fuel gas out of the cell stacked body 10.

A plurality of flow paths (manifolds) extending in the front-rear direction so as to communicate with the through-holes 211 to 216 are formed at both end portions of the cell stacked body 10 in the left-right direction. The fuel gas supplied through the through-hole 211 is guided to the anode flow path inside the cell stacked body 10, and the oxidant gas supplied through the through-hole 214 is guided to the cathode flow path. As a result, power is generated in the power generation cells 1. The supplied fuel gas and oxidant gas are discharged from the cell stacked body 10 through the through-holes 216 and 213, respectively. The cooling medium supplied through the through-hole 215 is guided to the cell stacked body 10, and thus the power generation surface is cooled. The cooling medium is discharged through the through-hole 212 after passing through the cell stacked body 10

The fuel cell stack 100 according to the present embodiment is particularly characterized by the configuration of the case 30. FIG. 2 is a cross-sectional view taken along II-II line in FIG. 1. As illustrated in FIG. 2, the side walls 300 of the case 30 include an upper wall 31, a right wall 32, a lower wall 33, and a left wall 34, which are respectively opposed to the upper surface, the right surface, the lower surface, and the left surface of the cell stacked body 10. Hereinafter, the center of the accommodation space SP0 in the case will be referred to as a case inner side. The upper wall 31, the right wall 32, the lower wall 33, and the left wall 34 each includes an inner surface 30a (a first surface) facing the accommodation space SP0, and an outer surface 30b (a second surface) opposite the accommodation space SP.

Guide support portions 35 for supporting the guide members 50 are provided on the inner surfaces 30a of the side walls 300 facing the accommodation space SP0, that is, the lower surface of the upper wall 31, the left surface of the right wall 32, the upper surface of the lower wall 33, and the right surface of the left wall 34. The guide support portion 35 protrudes from the inner surface 30a of the side wall 300 to the case inner side, and extends in the longitudinal direction (front-rear direction) of the side wall 300. The guide support portion 35 has, for example, a recess 35a at a portion facing the accommodation space SP0. The guide member 50 is fitted into the recess 35a.

The guide support portion 35 can be provided on the side wall 300 itself, for example by machining the inner surface 30a of the side wall 300. The guide support portion 35 may be provided separately from the side wall 300, and fixed to the side wall 300 with a bolt or the like. Even when the guide support portion 35 is provided separately from the side wall 300, the inner surface 30a of the side wall 300 requires to be machined with a bearing surface, a bolt hole, or the like for attaching the guide support portion 35.

The guide member 50 is an elongated member made of resin extending in the front-rear direction, and is formed by, for example, extrusion molding. The cross-sectional shape of the guide member 50 is uniform in the longitudinal direction (front-rear direction). The guide member 50 has a recess 51 toward the case inner side, for example. The upper surface, the left surface, the lower surface and the right surface of the cell stacked body 10 are fitted into the recesses 51.

Specifically, on the upper surface, the left surface, the lower surface, and the right surface of the separator 3 of the cell stacked body 10, protrusions 11 are provided corresponding to the guide members 50, and the separators 3 are stacked while the protrusions 11 are fitted into the recesses 51. In this case, a single unitized electrode assembly 2 is joined with a single separator 3 in advance by welding, bonding, or the like to form a set of a unit cell, so that the unitized electrode assembly 2 can be simultaneously stacked when the separator 3 is stacked. Further, by stacking the separators 3 via the guide members 50, the cell stacked body 10 can be configured while accurately positioning the separators 3 with respect to the case 30.

The case 30 is formed such that the end portions of the side walls 300 are joined to each other after the processing of the guide support portion 35 and the like of the side wall 300 is completed. Specifically, the upper end surface of the right wall 32 and the upper end surface of the left wall 34 are joined to the right end portion and the left end portion of the inner surface 30a of the upper wall 31, respectively. The lower end surface of the right wall 32 and the lower end surface of the left wall 34 are joined to the right end portion and the left end portion of the inner surface 30a of the lower wall 33, respectively. Friction stir welding is used for these joints.

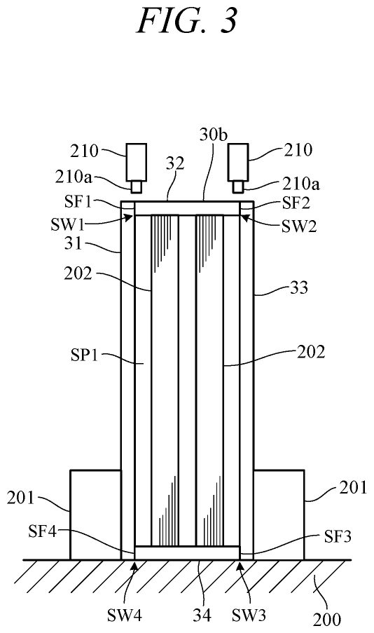

FIG. 3 is a view illustrating an example of a step of joining the right wall 32 and then upper wall 31, and the right wall 32 and the lower wall 33. In the joining step of FIG. 3, first, the left wall 34 is placed on a base 200. Further, the upper wall 31 and the lower wall 33 are erected on the base 200 in a state where the upper wall 31 and the lower wall 33 are brought into contact with both end surfaces of the left wall 34. At this time, both sides of the upper wall 31 and the lower wall 33 are held by blocks 201 so that the upper wall 31 and the lower wall 33 do not fall outward. Next, a jig 202 having a predetermined length is installed on an upper surface of the left wall 34, and the right wall 32 is mounted on an upper surface of the jig 202. That is, the jig 202 is installed in a space SP1 surrounded by the upper wall 31, the right wall 32, the lower wall 33, and the left wall 34.

At this time, a height of the jig 202 is set such that a surface of the right wall 32 is located at the same height as an end surface of the upper wall 31 and an end surface of the lower wall 33. With such a configuration, in a state where the upper wall 31 and the lower wall 33 are brought into contact with both end faces of the right wall 32, the right wall 32 can be held by the jig 202 so as to resist a pushing-down load from above. A state of the side wall 300 before joining may be referred to as a workpiece. Therefore, FIG. 3 illustrates a workpiece joining step.

In this state, a tool 210 is pressed from above against a connection surface SF1 between the end surface of the right wall 32 and the upper wall 31 and a connection surface SF2 between the end surface of the right wall 32 and the lower wall 33 while rotating the tool 210 including a probe 210a having a substantially cylindrical shape at a tip. Accordingly, the connection surface SF1 and the connection surface SF2 are joined by friction stir welding. Next, an entire workpiece is vertically inverted, and a connection surface SF4 between the end surface of the left wall 34 and the upper wall 31 and a connection surface SF3 between the end surface of the left wall 34 and the lower wall 33 are similarly subjected to friction stir welding. Thus, a case 30 is manufactured.

After friction stir welding, the connection surfaces SF1 to SF4 do not exist, and the connection surfaces SF1 to SF4 become joint portions SW1 to SW4, respectively. Sizes of the joint portions SW1 to SW4 are determined by a diameter of a tool distal end portion, and the joint portions SW1 to SW4 exist in a predetermined region around the connection surfaces SF1 to SF4.

Since the side walls 300 are joined to each other by friction stir welding in this manner, a joining strength is high, and deformation and distortion due to joining are also small. Therefore, guide members 50 can be easily fitted to guide support portions 35 provided in advance on the inner surfaces 30a of the case 30. In an example of FIG. 3, the connection surfaces SF1 and SF2 are provided on both end surfaces of the right wall 32. Therefore, the tool 210 can be brought close to the workpiece from the same direction without changing a posture of the workpiece, and the two connection surfaces SF1 and SF2 can be joined. As a result, the number of posture changes of the workpiece is reduced, and efficient joining can be performed.

As shown in FIG. 2, a voltage control unit (VCU) 205 for controlling power generation of the fuel cell stack 100 is mounted on an upper surface of the case 30 (upper wall 31). A joint portion between the side walls 300 is not provided on the upper surface of the upper wall 31, and the upper surface is formed flat without unevenness. Therefore, the voltage control unit 205 can be favorably mounted on the upper surface of the upper wall 31 without rattling.

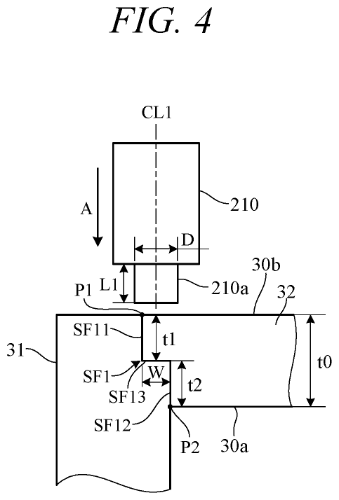

In FIG. 3, each of the connection surfaces SF1 to SF4 of the side walls 300 is configured by a single plane, but may be configured by a plurality of planes perpendicular to each other. FIG. 4 is a diagram illustrating an example of such a configuration and illustrating another example of the connection surface SF1 between the upper wall 31 and the right wall 32.

In FIG. 4, the connection surface SF1 includes a plurality of connection surfaces SF11, SF12, and SF13. That is, the connection surface SF1 includes an outer connection surface SF11 provided on the end surface of the right wall 32 and extending perpendicularly to the outer surface 30b by a predetermined length t1 from the outer surface 30b to the inner surface 30a of the side wall 300 (right wall 32), an inner connection surface SF12 extending perpendicularly to the inner surface 30a from the inner surfaces 30a to the outer surface 30b by a predetermined length t2, and an intermediate connection surface SF13 that is orthogonal to the outer connection surface SF11 and the inner connection surface SF12 and connects the outer connection surface SF11 and the inner connection surface SF12.

In other words, the connection surface SF1 includes a pair of connection surfaces (outer connection surface SF11, inner connection surface SF12) offset from each other in a direction perpendicular to an axis CL1 which is a rotation center of the tool 210, and a connection surface (intermediate connection surface SF13) connected to each of the connection surfaces SF11 and SF12 in an L shape. Therefore, each of the end surface of the upper wall 31 and the end surface of the right wall 32 facing and abutting each other is formed in a stepped shape. The outer connection surface SF11 extends in a plate thickness direction from a predetermined position P1 that is an end of the outer surface 30b of the right wall 32. The inner connection surface SF11 extends in a plate thickness direction from a predetermined position P2 which is an end portion of the inner surface 30a of the right wall 32 and is offset from the outer connection surface SF11 by a predetermined amount W in a direction orthogonal to the plate thickness direction.

The offset amount W (length of the connection surface SF13) of the pair of connection surfaces SF11 and SF12 is set to a value smaller than a diameter D of the probe 210a of the tool distal end portion. The connection surfaces SF11 and SF12 are provided at equal distances with the axis CL1 interposed therebetween. The length t1 of the outer connection surface SF11 is set to be equal to or less than a length L1 of the probe 210a. A value obtained by subtracting the length t1 from a plate thickness to of the side wall 300 is a length t2 of the inner connection surface SF12. Although not illustrated, the other connection surfaces SF2 to SF4 are configured similarly to FIG. 4.

The tool 210 is pressed perpendicularly to the outer surface 30b in a state where the axis CL1 coincides with the center of the connection surfaces SF11 and SF12, and is moved until the distal end portion of the probe 210a reaches the inner surface 30a. At this time, the intermediate connection surface SF13 receives a pressing load of the tool 210, which makes it possible to prevent a position of the right wall 32 from being shifted in A1 direction in FIG. 4 with respect to the upper wall 31, and makes it possible to perform friction stir welding with high accuracy. The jig 202 in FIG. 3 can be eliminated.

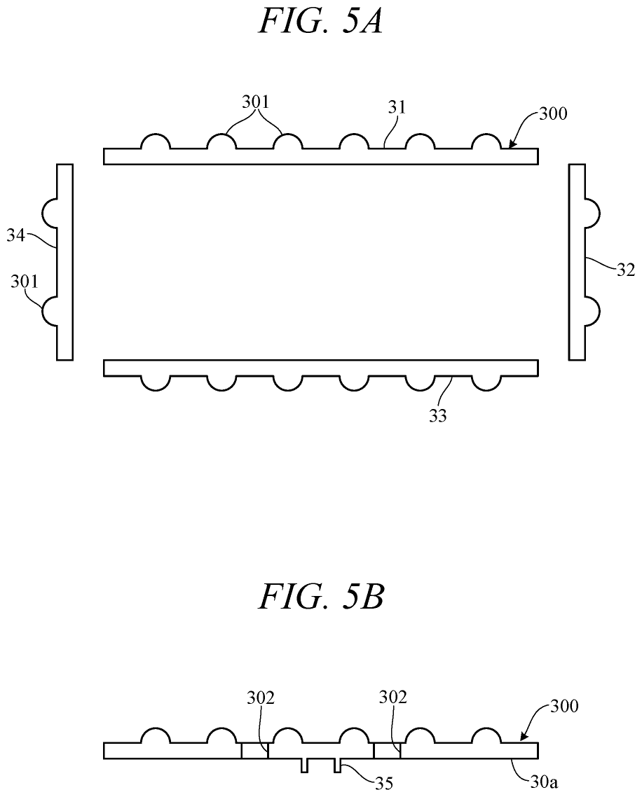

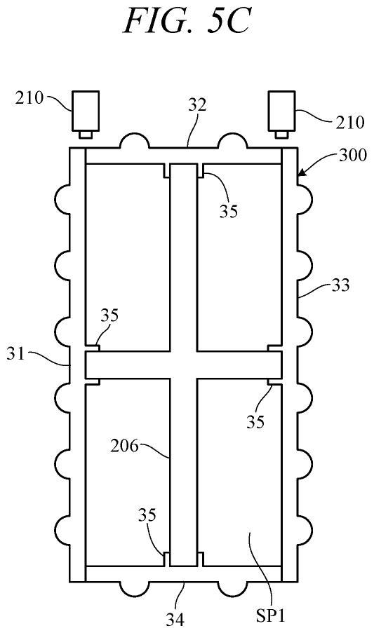

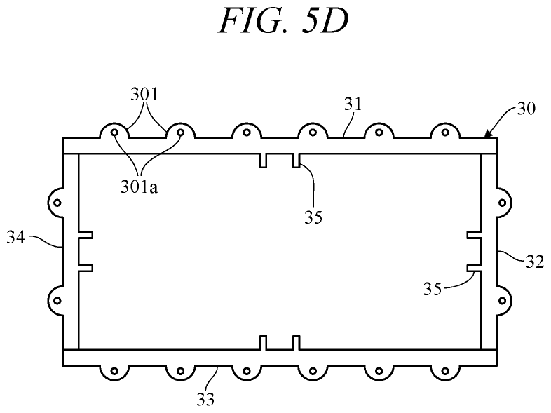

A manufacturing method of the case 30 is summarized as follows. First, as shown in FIG. 5A, four side walls 300 made of substantially plate-like metal, that is, the upper wall 31, the right wall 32, the lower wall 33, and the left wall 34 are manufactured. These side walls 300 are manufactured by, for example, forging, casting, or extrusion (side wall manufacturing step). In the side wall manufacturing step, the flange portions 301 for attaching the end plate 21 (FIG. 1) are provided on end surfaces of the side walls 300.

Next, as illustrated in FIG. 5B, the side walls 300 are set on a processing table (not illustrated), and necessary machining is performed on the side walls 300 (pre-processing step). For example, the through-holes 302 through which the cable connected to the sensor passes are processed. In the pre-processing step, a step of providing the guide support portions 35 on the inner surfaces 30a of the side wall 300 is also performed. At this stage, since the inner surfaces 30a are exposed, various processing can be easily performed on the side walls 300. In the side wall manufacturing step, the guide support portions 35 may be provided on the side walls 300, and then, in the pre-processing step, processing (cutting processing, drilling processing, and the like) may be performed on the guide support portions 35.

Next, as illustrated in FIG. 3, the connection surfaces SF1 to SF4 of the side walls 300 are joined using the jig 202 (joining step). That is, while rotating the tool 210, the tool 210 is pressed from above the connection surfaces SF1 to SF4 to join the connection surfaces SF1 to SF4 by friction stir welding. Instead of FIG. 3, a joining step may be performed as illustrated in FIG. 5C. In FIG. 5C, a substantially cross-shaped jig 206 is installed in the space SP1 surrounded by the side walls 300. An upper end portion, a lower end portion, a right end portion, and a left end portion of the jig 206 are fitted to the guide support portions 35 on the inner surfaces 30a of the side walls 300. Thus, the jig 206 can be easily held by using the guide support portions 35 for supporting the guide members 50.

Next, as illustrated in FIG. 5D, bolt holes 301a are processed in the flange portions 301 of the case 30 (post-processing step). Since the flange portions 301 are provided at the end portion of the case 30, the flange portions 301 can be easily processed even in a state where the case 30 is assembled. Thus, the manufacturing of the case 30 is completed.

Thereafter, when the fuel cell stack 100 is assembled, the guide members 50 are fitted to the guide support portions 35 (recesses 35a) of the case 30 as shown in FIG. 2. Then, a predetermined number of the separators 3 are stacked together with the unitized electrode assemblies 2 along the guide members 50 to form the cell stacked body 10. Further, a pressing force is applied to both ends of the cell stacked body 10 through the end units 20 by a pressing machine to compress the cell stacked body 10 to a predetermined length. Then, in this state, the flange portions 301 of the case 30 are fastened to the end plate 21 using bolts.

According to the present embodiment, the following effects can be achieved.

(1) A fuel cell stack 100 includes: a cell stacked body 10 having a substantially rectangular parallelepiped shape formed by alternately stacking a unitized electrode assembly 2 including an electrolyte membrane and an electrode, and separators 3 in the front-rear direction; and a case 30 having four side walls 300 facing four side surfaces of the cell stacked body 10 extending in the front-rear direction, that is, an upper wall 31, a right wall 32 continuous with the upper wall 31, a lower wall 33 continuous with the right wall 32, and a left wall 34 continuous with the lower wall 33 and the upper wall 31, and forming an accommodation space SP0 for accommodating the cell stacked body 10 (FIGS. 1 and 2). Each of the upper wall 31, the right wall 32, the lower wall 33, and the left wall 34 is formed of a substantially plate-like member having a substantially rectangular shape (FIG. 1). The case 30 includes joint portions SW1 to SW4 joined to a connection surface SF1 between the upper wall 31 and the right wall 32, a connection surface SF2 between the right wall 32 and the lower wall 33, a connection surface SF3 between the lower wall 33 and the left wall 34, and a connection surface SF4 between the left wall 34 and the upper wall 31 by friction stir welding, respectively (FIG. 3). Further, the case 30 has a machined guide support portion 35 on an inner surface 30a of the side wall 300 (for example, the upper wall 31) facing the accommodation space SP0 (FIG. 2).

Since the case 30 is formed by joining the four side walls 300 by friction stir welding with less distortion at the time of joining as described above, various types of machining can be performed on the inner surfaces 30a and the outer surfaces 30b of the side walls 300 before joining the side walls 300, that is, in a stage where each of the side walls 300 is a single body. Therefore, for example, when machining for providing the guide support portion 35 on the inner surfaces 30a of the upper wall 31 is required, the machining can be easily performed. That is, when the inner surfaces 30a of the case 30 is processed in an assembled state of the case 30, a dedicated tool or the like is required, but according to the present embodiment, a dedicated tool or the like is not required, and the case 30 of the fuel cell stack 100 can be easily and inexpensively configured.

(2) A connection surface SF1 between the upper wall 31 and the right wall 32 is a connection surface between an inner surface 30a of the upper wall 31 and an upper end surface of the right wall 32, a connection surface SF2 between the right wall 32 and the lower wall 33 is a connection surface between an inner surface 30a of the lower wall 33 and a lower end surface of the right wall 32, a connection surface SF3 between the lower wall 33 and the left wall 34 is a connection surface between the inner surface 30a of the lower wall 33 and a lower end surface of the left wall 34, and a connection surface SF4 between the left wall 34 and the upper wall 31 is a connection surface between an inner surface 30a of the upper wall 31 and an upper end surface of the left wall 34 (FIGS. 2 and 3). As a result, the joint portion is not exposed on the upper surface of the upper wall 31, and the upper surface can be a flat surface without unevenness. Therefore, devices such as the voltage control unit 205 can be stably mounted on the upper surface of the upper wall 31. In addition, the joint portion is not exposed on the lower surface of the lower wall 33, and the lower surface can be a flat surface without unevenness. Therefore, the fuel cell stack 100 can be stably mounted on a vehicle body. Furthermore, since the connection surfaces SF1, SF2 and SF3, SF4 are provided on both end surfaces of the right wall 32 and both end surfaces of the left wall 34, respectively, the tool 210 can be pressed against the plurality of connection surfaces SF1 and SF2 and the plurality of connection surfaces SF3 and SF4 from the same direction. Therefore, the number of posture changes of the workpiece is small, and the side walls 300 can be efficiently joined.

(3) The fuel cell stack 100 further includes guide members 50 that are respectively interposed between the upper wall 31 and the cell stacked body 10, between the right wall 32 and the cell stacked body 10, between the lower wall 33 and the cell stacked body 10, and between the left wall 34 and the cell stacked body 10, and extend in the front-rear direction (FIG. 2). Each of the upper wall 31, the right wall 32, the lower wall 33, and the left wall 34 has a guide support portion 35 that supports the guide member 50 on the inner surface 30a (FIG. 2). The guide support portions 35 are formed by machining. In the present embodiment, since the guide support portions 35 are formed before the side walls 300 are joined, the guide support portions 35 can be accurately formed. Accordingly, the guide members 50 can be easily and accurately attached to the inner surface 30a of the side walls 300, and the plurality of power generation cells 1 can satisfactorily be stacked along the guide members 50.

(4) A manufacturing method of a case 30 used for the fuel cell stack 100 includes: a step (side wall manufacturing step) of manufacturing an upper wall 31, a right wall 32, a lower wall 33 and a left wall 34 each extending in a substantially rectangular shape and configured in a substantially plate shape; a step (pre-processing step) of machining surfaces of the upper wall 31, the right wall 32, the lower wall 33 and the left wall 34; and a step (joining step) of joining by a friction stir welding the upper wall 31 and the right wall 32 disposed substantially perpendicular to each other, the right wall 32 and the lower wall 33 disposed substantially perpendicular to each other, the lower wall 33 and the left wall 34 disposed substantially perpendicular to each other, and the left wall 34 and the upper wall 31 disposed substantially perpendicular to each other, by pressing a substantially cylindrical shaped tool (a joining tool) 210 onto a connection surface SF1 between the upper wall 31 and the right wall 32, a connection surface SF2 between the right wall 32 and the lower wall 33, a connection surface SF3 between the lower wall 33 and the left wall 34, and a connection surface SF4 between the left wall 34 and the upper wall 31 while rotating the tool 210 along the connection surfaces (FIGS. 3, 5B and 5C). The joining step includes disposing a jig 202 or 206 receiving a pushing load in a space SP1 surrounded by the upper wall 31, the right wall 32, the lower wall 33 and the left wall 34 (FIGS. 3 and 5C). With this configuration, since the side wall 300 can be machined before the joining step, even when machining is required inside the case 30, the case 30 can be easily and inexpensively manufactured without using a dedicated tool.

(5) The connection surface SF1 between the upper wall 31 and the right wall 32 may include: an outer connection surface SF11 extending continuous with an outer surface 30b of the right wall 32 by a predetermined length t1 in a thickness direction of the right wall 32; an inner connection surface SF12 extending continuous with an inner surface 30a of the right wall 32 by a predetermined length t2 in the thickness direction of the right wall 32, in a position P2 offsetting from the outer connection surface SF11 to a direction perpendicular to the thickness direction of the right wall 32 by a predetermined length W; and an intermediate connection surface SF13 extending in the direction perpendicular to the thickness direction of the right wall 32 to connect the outer connection surface SF11 and the inner connection surface SF12 (FIG. 4). Accordingly, when the pressing load is applied from the tool 210 in the joining step, the positional displacement of the right wall 32 with respect to the upper wall 31 in the connection surface SF1 can be prevented, and the joining on the connection surface SF1 can be easily and accurately performed.

(6) The pre-processing step includes processing a guide support portion 35 supporting a guide member 50 extending substantially parallel to the connection surface SF1 to SF4 (in the front-rear direction), the guide member 50 for accommodating the separator 3 in the space SP1 while guiding the separator 3, on each of the inner surfaces 30a (on a side facing the space SP1) of the upper wall 31, the right wall 32, the lower wall 33 and the left wall 34. The joining step includes joining in a state of supporting the jig 206 by the guide support portion 35 (FIG. 5C). Since the jig 206 is supported via the guide support portion 35 in this manner, the jig 206 for counteracting the pressing load of the tool 210 can be stably held in the case.

The above-described embodiment can be varied into various forms. Some variations will be described below. In the above-described embodiment, the guide support portion 35 is provided as a machined portion on each of the four side walls 300, but the configuration of the machined portion is not limited thereto. The guide member 50 and the guide support portion 35 may not be provided. As long as the machined portion is provided on at least an inner surface of a first side wall, the machining portion may not be provided on a second side wall, a third side wall, and a fourth side wall. Here, the first side wall is any one of the upper wall 31, the right wall 32, the lower wall 33, and the left wall 34, the second side wall is a side wall connected to the first side wall, the third side wall is a side wall connected to the second side wall, and the fourth side wall is a side wall connected to the third side wall and the first side wall.

In the above-described embodiment, the stacked body (cell stacked body 10) is configured by stacking alternately the unitized electrode assembly 2 having an electrolyte membrane and an electrode, and the separator 3 in the front-rear direction (predetermined direction), but the stacked direction may be a direction other than the front-rear direction, for example, the up-down direction. In the above-described embodiment, the four side walls 300 are formed in a substantially plate shape so that the side walls 300 do not include a bent portion at the end portion, but any of the four side walls 300 may include a bent portion bent by 90° at the end portion. That is, the side wall 300 may have a substantially L-shaped cross section. In the above-described embodiment, the pair of connection surfaces SF1 and SF2 and the pair of connection surfaces SF3 and SF4 respectively extend in the same direction (the up-down direction in FIG. 3), but they may extend in different directions.

In the above-described embodiment (FIG. 4), by using the upper wall 31 as a first side wall and using the right wall 32 as a second side wall, the connection surface SF1 is configured so as to include the outer connection surface SF11 (a first connection surface) extending from the end surface of the outer surface 30b (predetermined position P1) which is a surface on one side of the right wall 32 in the thickness direction of the right wall 32 by a predetermined length t1 (a first length), the inner connection surface SF12 (a second connection surface) extending from a predetermined position P2 offsetting from the outer connection surface SF11 on the inner surface 30a which is a surface on the other side of the right wall 32 by a predetermined length W, in the thickness direction of the right wall 32 by a predetermined length t2 (a second length), and the intermediate connection surface SF13 (a third connection surface) extending perpendicular to the thickness direction of the right wall 32 to connect the outer connection surface SF11 and the inner connection surface SF12, but the configurations of the first side wall and the second side wall are not limited thereto. The first side wall may be other than the upper wall 31, that is, any of the right wall 32, the lower wall 33, and the left wall 34, and the second side wall may be other than the right wall 32, that is, any of the upper wall 31, the lower wall 33, and the left wall 34.

Although an example in which the cell stacked body 10 is accommodated in the case 30 of the fuel cell stack 100 has been described above, a case of the present invention can also be used as a case other than the fuel cell stack. Therefore, an accommodated object accommodated in the case is not limited to the cell stacked body.

The above embodiment can be combined as desired with one or more of the above modifications. The modifications can also be combined with one another.

According to the present invention, machining can be inexpensively performed inside a case of a fuel cell stack.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body configured to stack alternately a unitized electrode assembly having an electrolyte membrane and an electrode, and a separator in a predetermined direction, the cell stacked body having a substantially rectangular parallelepiped shape; and
a case having four side walls facing four side surfaces of the cell stacked body extending in the predetermined direction to form an accommodation space accommodating the cell stacked body, the four side walls being a first side wall, a second side wall continuous with the first side wall, a third side wall continuous with the second side wall, and a fourth side wall continuous with the third side wall and the first side wall, wherein
each of the four side walls includes a first surface facing the accommodation space and a second surface on an opposite side of the accommodation space and is configured by a substantially plate-shaped member having a substantially rectangular shape,
the case includes a joint portion joined by a friction stir welding on each of a connection surface between the first side wall and the second side wall, a connection surface between the second side wall and the third side wall, a connection surface between the third side wall and the fourth side wall, and a connection surface between the fourth side wall and the first side wall, and
the case further includes a machined portion on at least the first surface of the first side wall facing the accommodation space.

2. The fuel cell stack according to claim 1, wherein
the connection surface between the first side wall and the second side wall is a connection surface between the first surface of the first side wall and an end surface of the second side wall,
the connection surface between the second side wall and the third side wall is a connection surface between the first surface of the third side wall and another end surface of the second side wall,
the connection surface between the third side wall and the fourth side wall is a connection surface between the first surface of the third side wall and an end surface of the fourth side wall, and
the connection surface between the fourth side wall and the first side wall is a connection surface between the first surface of the first side wall and another end surface of the fourth side wall.

3. The fuel cell stack according to claim 2, further comprising
an attachment component attached on the second surface of the first side wall.

4. The fuel cell stack according to claim 1, further comprising
guide members interposed between the first side wall and the cell stacked body, between the second side wall and the cell stacked body, between the third side wall and the cell stacked body, and between the fourth side wall and the cell stacked body to extend in the predetermined direction,
each of the first side wall, the second side wall, the third side wall and the fourth side wall includes a guide support portion supporting each of the guide members on the first surface, and
the guide support portion is the machined portion.

5. The fuel cell stack according to claim 1, wherein
the first side wall includes a flange portion at an end in the predetermined direction, and
a through-hole passing through the flange portion in the predetermined direction is provided at the flange portion.

6. A manufacturing method of a case, comprising:
manufacturing four side walls each including a first surface ant a second surface on an opposite side of the first surface and formed in a substantially rectangular and plate shape, the four side walls including a first side wall, a second side wall, a third side wall and a fourth side wall;
machining at least the first surface of the first side wall among the four side walls; and
joining by a friction stir welding the first side wall and the second side wall disposed perpendicular to each other, the second side wall and the third side wall disposed perpendicular to each other, the third side wall and the fourth side wall disposed perpendicular to each other, and the fourth side wall and the first side wall disposed perpendicular to each other in a state where the first surface of the first side wall and the first surface of the third side wall are disposed opposite to each other and the first surface of the second side wall and the first surface of the fourth side wall are disposed opposite to each other, the friction stir welding being performing by pressing a joining tool onto a connection surface between the first side wall and the second side wall, a connection surface between the second side wall and the third side wall, a connection surface between the third side wall and the fourth side wall, and a connection surface between the fourth side wall and the first side wall while rotating the joining tool along the connection surface, respectively, wherein
the joining includes disposing a jig in a space surrounded by the first side wall, the second side wall, the third side wall and the fourth side wall.

7. The manufacturing method of the case according to claim 6, wherein
the connection surface between the first side wall and the second side wall includes:
a first connection surface extending continuous with one of the first surface and the second surface of the second side wall by a first length in a thickness direction of the second side wall;
a second connection surface extending continuous with the other of the first surface and the second surface of the second side wall by a second length in the thickness direction of the second side wall, in a position offsetting from the first connection surface to a direction perpendicular to the thickness direction of the second side wall by a predetermined length; and
a third connection surface extending in the direction perpendicular to the thickness direction of the second side wall to connect the first connection surface and the second connection surface.

8. The manufacturing method of the case according to claim 6, wherein
the machining includes processing a guide support portion supporting a guide member extending substantially parallel to the connection surface so as to accommodate an accommodated object in the space while guiding the accommodated object, on each of the four side walls, and
the joining by the friction stir welding includes joining in a state of supporting the jig by the guide support portion.

9. The manufacturing method of the case according to claim 6, wherein
the case is a case of a fuel cell stack accommodating a cell stacked body configured by stacking alternately a unitized electrode assembly having an electrolyte membrane and an electrode, and a separator in a predetermined direction and having a substantially rectangular parallelepiped shape.

10. The manufacturing method of the case according to claim 9, further comprising
machining an end portion in the predetermined direction on the second surface of at least any of the first side wall, the second side wall, the third side wall and the fourth side wall after joining by the friction stir welding.
